(19) United States
(12) Patent Application Publication
(10) Pub. No.: US 2026/0113402 A1
(43) Pub. Date: Apr. 23, 2026

(54) AUTOMATED VOICEMAIL DETECTION

(71) Applicant: Advanis Inc., Edmonton (CA)

(72) Inventor: Michael Williams, Edmonton (CA)

(21) Appl. No.: 19/195,317

(22) Filed: Apr. 30, 2025

Related U.S. Application Data
(60) Provisional application No. 63/710,342, filed on Oct. 22, 2024.

(51) Int. Cl. H04M 3/22; H04M 3/533

(52) U.S. Cl. CPC H04M 3/2281; H04M 3/533

(57) ABSTRACT

Examples herein relate to a method and system for automated voicemail detection. In at least one example the method includes initiating a call to a telephone number associated with a user device; capturing at least one audio sample frame from the call; analyzing the audio sample frame to determine if the call is a voicemail call; and if the call is a voicemail call, dropping the call connection, otherwise connecting the call to an agent operator device.

### CROSS-REFERENCE TO RELATED APPLICATION(S)

This application claims benefit of, and priority to, U.S. Provisional Application No. 63/710,342, titled “METHOD AND SYSTEM FOR AUTOMATED VOICEMAIL DETECTION”, filed on Oct. 22, 2024, which is incorporated herein by reference in its entirety.

### FIELD

Various examples are described herein that generally relate to voicemail detection during telephone calls, and in particular, to a method and system for automated voicemail detection.

### BACKGROUND

Call centers often employ predictive dialers to optimize agent productivity. Predictive dialers aim to ensure that agents are available to respond immediately when a human (respondent) answers, while avoiding situations where agents listen to non-productive calls, such as those not in service or diverted to voicemail.

### SUMMARY

In at least one broad aspect, there is provided a method for automated detection of voicemail calls, the method comprising: initiating a call to a telephone number associated with a user device; capturing at least one audio sample frame from the call; analyzing the audio sample frame to determine if the call is a voicemail call; and if the call is a voicemail call, dropping the call connection, otherwise connecting the call to an agent operator device.

In some examples, analyzing the audio sample frame to determine if the call is a voicemail call comprises comparing each audio sample frame to a reference voicemail sample associated with the telephone number.

In some examples, the comparison is performed by comparing an array of the audio sample to an array of the reference voicemail sample.

In some examples, the comparison is performed by determining a cross correlation between the two numerical arrays.

In some examples, the call is determined to be a voicemail call if the highest normalized correlation value exceeds a predetermined threshold.

In some examples, analyzing the audio sample frame to determine if the call is a voicemail call comprises applying a live voicemail detection model to the audio sample frames, the live voicemail detection model comprising a trained machine learning model.

In some examples, prior to analyzing, the method comprises applying ringtone detection to detect audio sample frames comprising a ringtone, and analyzing audio sample frames not comprising a ringtone.

In some examples, the ringtone detection is performed using a Goertzel algorithm.

In some examples, the method further comprises initially generating the reference voicemail sample by: initiating an initial call to the telephone number; recording the initial call to generate an audio call recording; applying a recorded voicemail detection model to the audio call recording to determine if the audio call is a voicemail call; if the call is a voicemail call, extracting a reference voicemail sample from the audio call recording; and storing the reference voicemail sample in association with the telephone number.

In some examples, the method further comprises applying a tone detection model to the audio call recording to determine if the audio call recording is a voicemail call.

In another broad aspect, there is provided a system (e.g., a server system) for automated detection of voicemail calls, the system comprising: a communication interface; and at least one processor coupled to the communication interface, the at least one processor configured for: initiating, via the communication interface, a call to a telephone number associated with a user device; capturing at least one audio sample frame from the call; analyzing the audio sample frame to determine if the call is a voicemail call; and if the call is a voicemail call, dropping the call connection, otherwise connecting the call to an agent operator device.

In some examples, analyzing the audio sample frame to determine if the call is a voicemail call comprises the at least one processor being configured for: comparing each audio sample frame to a reference voicemail sample associated with the telephone number.

In some examples, the comparison is performed by comparing an array of the audio sample to an array of the reference voicemail sample.

In some examples, the comparison is performed by determining a cross correlation between the two numerical arrays.

In some examples, the call is determined to be a voicemail call if the highest normalized correlation value exceeds a predetermined threshold.

In some examples, analyzing the audio sample frame to determine if the call is a voicemail call comprises the at least one processor being configured for: applying a live voicemail detection model to the audio sample frames, the live voicemail detection model comprising a trained machine learning model.

In some examples, prior to analyzing, the at least one processor is further configured for: applying ringtone detection to detect audio sample frames comprising a ringtone, and analyzing audio sample frames not comprising a ringtone.

In some examples, the ringtone detection is performed using a Goertzel algorithm.

In some examples, the at least one processor is further configured for, initially generating the reference voicemail sample by: initiating an initial call to the telephone number; recording the initial call to generate an audio call recording; applying a recorded voicemail detection model to the audio call recording to determine if the audio call is a voicemail call; if the call is a voicemail call, extracting a reference voicemail sample from the audio call recording; and storing the reference voicemail sample in association with the telephone number.

In some examples, the at least one processor is further configured for: applying a tone detection model to the audio call recording to determine if the audio call recording is a voicemail call.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 is an example system for automated detection of voicemails.

FIG. 2A is a process flow for an example method for automated detection of voicemails.

FIG. 2B is a process flow for an example method for generating a reference voicemail sample.

FIG. 2C is a further process flow for an example method for automated detection of voicemails.

FIG. 3 is an illustrative figure showing multiple reference voicemails stored in association with the same telephone number.

FIG. 4A is a table exemplifying a model architecture for a recorded voicemail detection model.

FIG. 4B is a table exemplifying a model architecture for a voicemail tone detection model.

FIG. 4C is a table exemplifying a model architecture for a live voicemail detection model.

FIG. 5 is a simplified hardware block diagram for an example predictive dialing server.

Further aspects and features of the example embodiments described herein will appear from the following description taken together with the accompanying drawings.

### DETAILED DESCRIPTION

Examples herein generally relate to a method and system for automated voicemail detection.

### I. General Overview

As disclosed in the background section, predictive dialers are used in call centers to more effectively optimize agent productivity.

A problem with using predictive dialers arises in identifying calls answered by humans versus calls not in service or directed to voicemail. Ideally, the predictive dialer transfers only human-answered calls to agents while dropping voicemail calls. This, in turn, ensures that agents are not occupied with non-productive calls.

Detecting voicemail calls, however, is challenging because, when a call is connected to a voicemail system, there is no notification of this event to the predictive dialer. Rather, the system receives only an audio greeting message or tone corresponding to the voicemail.

Voicemail detection is also problematic because voicemail greetings differ for different voicemail systems. In many cases, voicemail greetings are also customized by the phone user to the point where it can be impossible to tell if it is a human greeting or a voicemail greeting in the first couple of seconds of the message. For example, some telephone users record a message along the lines of “Hello [long pause] leave a message after the tone”.

In view of the foregoing, disclosed examples provide a method and system for automated voicemail detection. As provided herein, disclosed examples enable a predictive dialer server to automatically detect calls forwarded to voicemail. If the call is forwarded to voicemail, the server can simply disconnect the call. This allows the system to only forward productive calls to agents, i.e., calls answered by a human.

### II. Example System

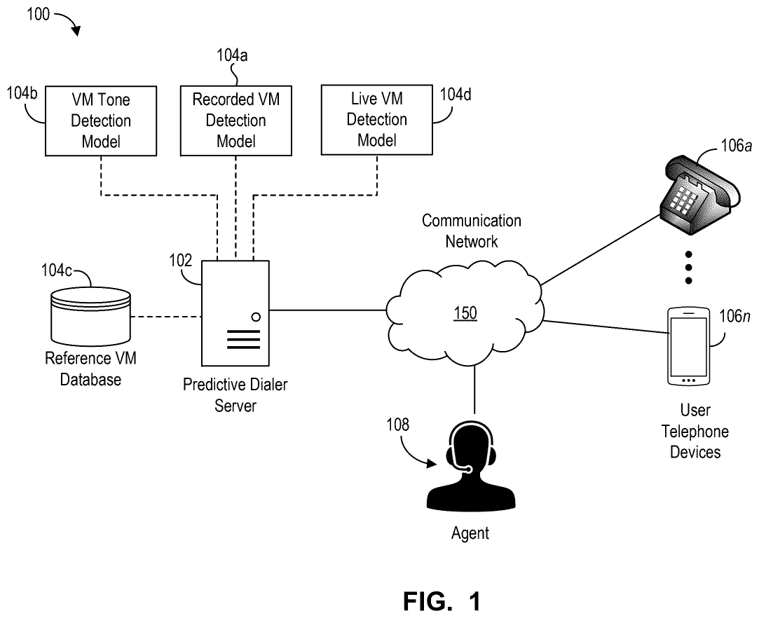

FIG. 1 is an example system 100 for automated detection of voicemails. As shown, system 100 generally includes a predictive dialer server 102 which couples, via a communication network 150, to one or more user telephone devices 106a-106n as well as a computer device 108 associated with a call agent.

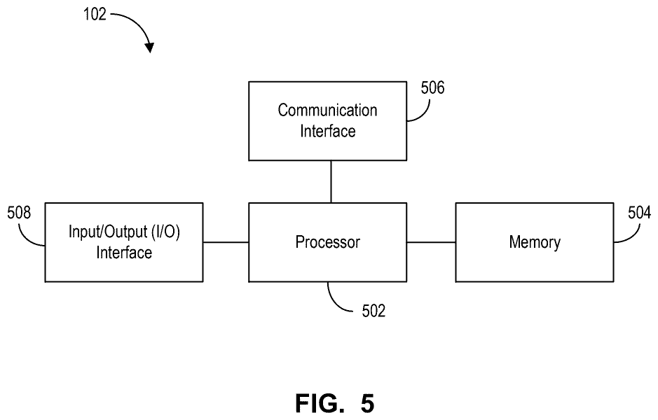

As provided below, and as exemplified in FIG. 5, server 102 generally includes a processor 502 coupled to a memory 504 and, in some cases, a communication interface 506 and input/output interface 508.

While the server 102 is referenced herein as a predictive dialer server 102, it is understood that server 102 more generally includes any type or form of computing server system. Further, as with all components in system 100, there may in fact be more than one server carrying out the function of server 102, e.g., using a distributed server architecture.

In operation, server 102 initiates calls to telephone numbers associated with different user devices 106a-106n. User devices 106a-106n include any computing devices operable to receive telephone calls over the communication network 150. By way of example, user devices 106 include traditional phones coupled to a land wire network 150, or mobile phones coupled to a wireless network 150. To this end, communication network 150 can be any combination of wired and/or wireless networks, as known in the art.

As disclosed herein, after calling a telephone number, server 102 further operates to automatically detect if the call is forwarded to voicemail. If the call is a voicemail call, then server 102 may simply disconnect the call. Otherwise, if the call is answered by a human, then server 102 may automatically connect the call to the agent device 108. In this manner, server 102 filters voicemail calls while connecting agents to calls answered by a human.

To enable the server 102 to automatically detect voicemail calls, server 102 hosts a number of models and databases 104a-104d. These include: (i) a recorded voicemail (VM) detection model 104a, (ii) a VM tone detection model 104b, (iii) a reference VM database 104c, and (iii) a live VM detection model 104d.

Recorded VM detection model 104a is applied when the system calls a user device 106 for the first time. After the system calls the user device, it generates an audio recording of the call. This audio recording is then analyzed by the recorded VM detection model 104a to determine if the recording includes a voicemail greeting. If this is the case, then the call is classified as a voicemail call.

In at least one example, the recorded VM model 104a is a machine learning model that is trained on standard voicemail audio greetings. This allows the recorded VM model 104a to identify voicemail greetings in recorded call audio.

The VM tone detection model 104b is used, in conjunction with the recorded VM model 104a, to also classify recorded calls as voicemail calls.

While the recorded VM model 104a detects voicemail greetings, the tone detection model 104b detects voicemail tones. This is because, in many cases, a voicemail call may not include a standard greeting but may include a custom greeting message followed by a voicemail tone. In some examples, the tone detection model 104b is also a machine learning model trained on various voicemail tones.

Reference VM database 104c stores reference voicemail audio samples associated with different telephone numbers.

More generally, after the recorded VM model 104a (or the VM tone model 104b) classifies recorded audio as a voicemail call—the system extracts sample voicemail audio from the recorded audio. The extracted reference voicemail sample is then stored in the reference database 104c in association with the telephone number. This enables the system to maintain a database of different voicemail audio samples for associated telephone numbers.

As further explained herein, when the system calls back the same telephone number, it can now access the reference VM database 104c to retrieve the VM sample associated with that number. The system then automatically determines if the call is forwarded to voicemail by simply comparing the call audio to the reference VM sample. If there is a sufficient match between the two audio samples, the system classifies the call as a voicemail call.

Live VM detection model 104d is also used to detect voicemails in calls. However, in contrast to the recorded VM detection model 104a, the live detection model 104d is applied while the call is in progress, i.e., rather than to recorded audio.

In at least one example, the live VM model 104b is also a machine learning model trained on standard voicemail audio greetings.

### III. Example Methods

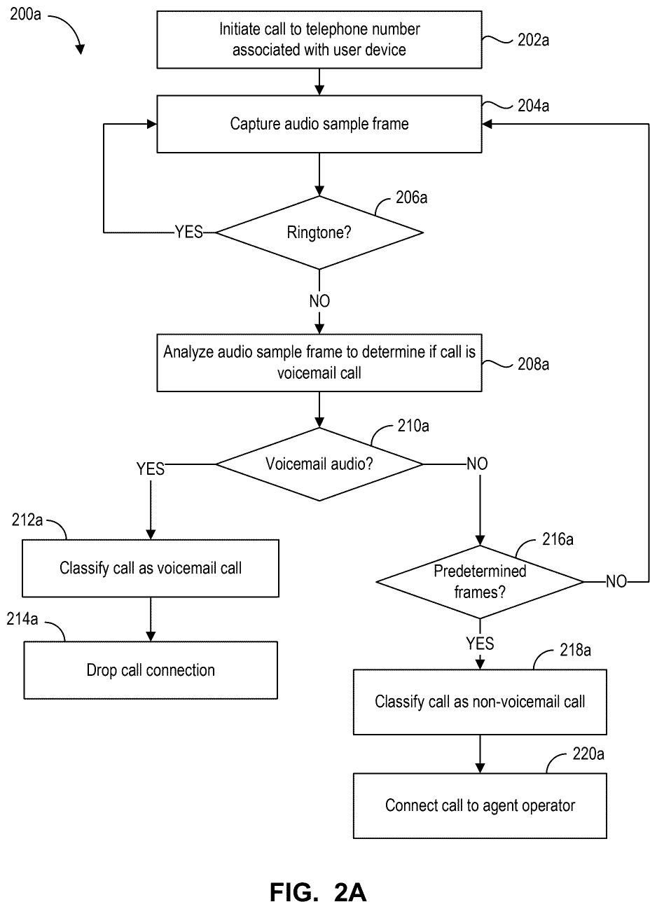

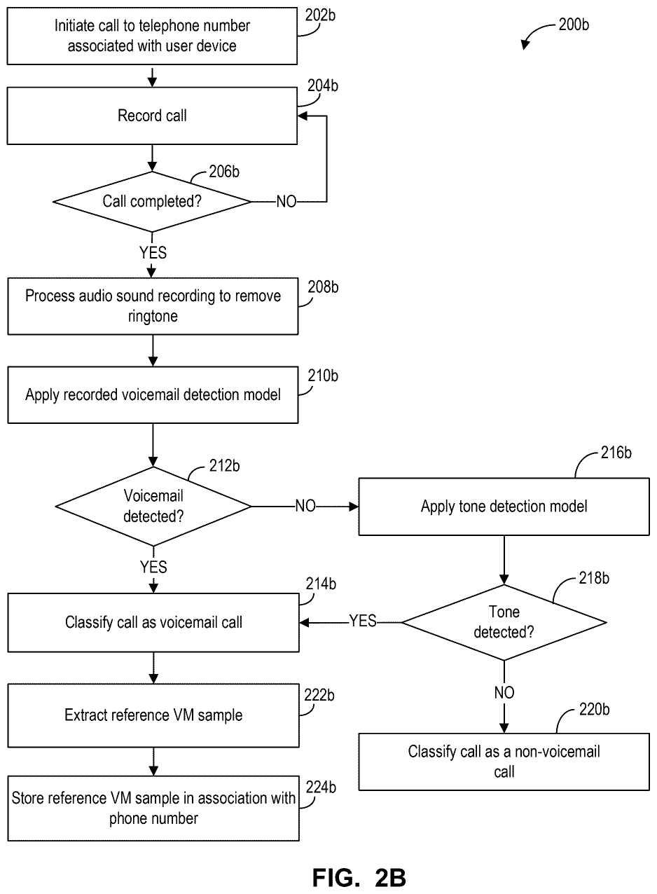

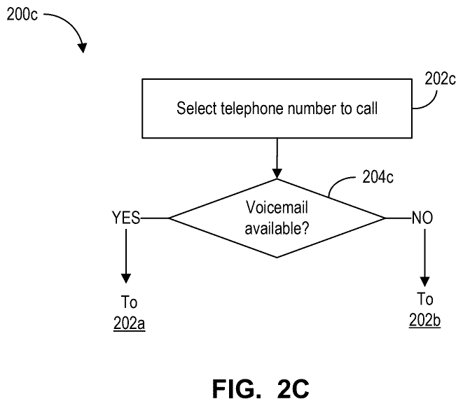

FIGS. 2A-2C show process flows for various example methods for automated detection of voicemails.

### (i.) Automated Detection of Voicemails

FIG. 2A shows a process flow for an example method 200a for automated detection of voicemails. In some examples, method 200a is performed or executed by a processor 502 of the predictive dialing server 102 (FIG. 5).

At 202a, a call is initiated to the telephone number associated with a user device 106. For example, the call is initiated over the communication network 150.

At 204a, the system captures one or more audio sample frames from the call. Each audio frame is of a predefined time duration, and may be in a range of 0.1˜0.2 seconds (e.g., 100 ms to 200 ms). The audio samples are analyzed to determine if the call is a voicemail call, or is otherwise answered by a human.

In at least one example, after capturing an audio sample, the system processes the audio frame to generate a PCM digital audio frame, e.g., comprising a digital numerical array. For instance, this involves converting the existing digital audio format (e.g., a μ-law digital format) to a 16-bit PCM (Pulse Code Modulation) array captured at a predefined sample rate (e.g., 8,000 samples per second). The advantage of this conversion is that, as compared to the more compact 8-bit μ-law format, the 16-bit PCM format enables analysis of the audio frame.

In some examples, the system captures audio sample frames, at act 204a, once it detects the earlier of: (i) a ring event, or (ii) a connection or confirmation event.

A ring event, as known in the art, is generated by telephone systems when the phone line starts ringing. Accordingly, the system can begin capturing audio frames when a ring event is initially detected.

On the other hand, a connection event is generated when the ringing stops, either because a human answered the phone, or the phone is forwarded to a voicemail message or a voicemail tone. It is possible that only a connection event is received if a ring event is not initially received.

At 206a, the system may filter out captured audio frames that include ringtone audio. This ensures that audio, of the telephone ringing, is not analyzed during voicemail detection and falsely classified as a voicemail tone.

It is noted that filtering the ringtone audio may be only relevant if the system begins capturing audio frames after a ring event. In contrast, if a connection event is initially received, the ringing is already completed. Accordingly, there may be no need to filter out ringtone audio (act 206a) if audio frames are captured after the connection event. In some cases, the system therefore initially determines the type of event received (e.g., ring or confirmation) and only applies act 206a if the audio frames are captured after the ring event.

In at least one example, the system determines if an audio frame includes ringing, at act 206a, by applying a ringtone detection technique. In some examples, the applied ringtone detection is a Goertzel algorithm. The algorithm identifies audio portions composed of target ringtone frequencies. The target ringtone frequencies can be, for instance, dual frequencies of 440 Hz and 480 Hz.

A sliding window may be applied to identify portions of the audio corresponding to a ringtone. For example, a 100 ms sliding window is used whereby 20 ms is iteratively added to the end of the window and removed from the front of the window. The duration of 20 ms is selected because this is the size of the audio frame received from Session Initiation Protocol (SIP) lines.

In some examples, ringtone audio is identified, using a sliding window technique, if it satisfies two conditions: (i) most of the windowed audio is accounted for by the target ringtone frequencies, e.g., identified using the Goertzel algorithm; and (ii) the amplitude of the target frequencies is equal within the window (i.e., the twist of the audio signal). If these conditions are satisfied, the system identify the audio portion as ringtone audio.

If the audio sample frames correspond to a ringtone at act 206a, the system returns to act 204a to continue monitoring for the next captured audio frame. Otherwise, the system proceeds to act 208a to analyze each subsequent ‘non-ringtone’ audio frame.

At 208a, each subsequent captured audio sample frame is analyzed to determine if the call is a voicemail call.

The audio frames are analyzed in various manners. In disclosed examples, the audio frames are analyzed either by: (i) using the live VM detection model 104d (FIG. 1); and/or (ii) comparing the captured audio sample to reference VM samples, stored in reference database 104c (FIG. 1).

In the first instance, the audio samples are analyzed using live VM detection model 104d. The live VM model 104d analyzes individually captured audio sample frames to determine whether the audio matches standard voicemail greetings. If so, then the system classifies the call as a voicemail call.

To this end, the live VM detection model 104d may be a machine learning model trained on standard voicemail greetings. The live VM detection model 104d receives an input comprising the digital audio frame (e.g., the numerical array), and analyzes the audio frame to classify the audio frame as voicemail audio or not.

In the second instance, the analysis at 208a is performed by comparing the captured audio samples to at least one reference VM sample, associated with the same telephone number. In this case, the system accesses a prerecorded reference voicemail (VM) sample (e.g., audio sample) associated with that telephone number. This is accessed, for example, from the reference VM database 104c.

More generally, reference VM database 104c stores prerecorded sample voicemails associated with different telephone numbers. As explained further on, in FIG. 2B, the reference VMs are generated (e.g., recorded) from prior calls made to the same number. In these prior calls, the call audio is recorded, and a reference voicemail sample is extracted from recorded audio and stored in the reference database 104c. In some examples, each reference VM sample may have a duration of approximately one second, e.g., 1,000 ms. This can be the first one second of the voicemail.

Accordingly, where a reference VM is used during the analysis at act 208a, the system can (i) initially, determine the telephone number associated with the user device, and (ii) subsequently, retrieves from the VM database 104c, the reference VM sample associated with that telephone number.

To enable a comparison between (i) the captured audio frame, and (ii) the reference VM audio for that number, at act 208a—the system can compare the numerical values in the two digital audio arrays. If there is sufficient similarity between the two arrays, then it is determined that the captured audio sample relates to a voicemail.

In at least one example, the comparison between the two arrays involves computing a cross correlation. Where the reference VM sample is longer than the captured audio sample, a cross correlation is computed for each alignment of the two arrays. For example, the reference voicemail may be a one second sample, while each captured audio frame is 0.2 seconds. As a result, the reference sample array is, for instance, 8,000 values long while the captured sample is 1,600 values long. Accordingly, a cross correlation technique is used to compare the similarity between the arrays.

If a cross correlation technique is used, then a match is detected if the cross correlation is higher than a predetermined threshold. For instance, a match is determined if the highest normalized correlation value between the two array is higher than 0.85. The threshold of 0.85 was determined by testing a large number of cases.

To this effect, at act 208a, the system can analyze the audio frame using one or both of the live VM detection model 104d and/or the comparison with a reference VM sample.

For example, it is possible that the system analyzes the captured audio frame using only one of the techniques. In other cases, the system uses both techniques to classify the call as a voicemail call. If both techniques are used, the system may require only one positive result to classify the call as a voicemail call. In other cases, the system may require that both techniques render a positive result to classify a voicemail call.

In still yet other examples, the techniques are used in the alternative. For example, the system may initially use the live VM detection model 104d. If the live VM detection model 104d renders a negative result (e.g., not voicemail audio), and then the system can compare the captured audio with a reference VM sample to confirm the negative result, or correct the negative result to a positive result. The order can also be swapped such that comparison with the VM sample occurs prior to applying the live VM detection model 104d. In all cases, however, the techniques may provide two confirmation points on classifying calls as voicemail calls.

In some instance, the system uses only the live VM detection model 104d if there are no reference VM samples available associated with the specific telephone number.

At 210a, based on the analysis at 208a, a determination is made as to whether the audio frame relates to voicemail audio.

If the audio frame is voicemail audio, then at 212a, the system determines (e.g., classifies) the call as a voicemail call. At 214a, the system may then automatically drop the call connection to avoid forwarding a “non-productive” voicemail call to the agent 108 (FIG. 1).

Otherwise, if the audio is not determined to be a voicemail audio, then at 216a, the system can determine whether it has analyzed a sufficient number of audio frames to properly classify the call. For example, the system may analyze a predetermined number of audio frames before conclusively classifying the call as a non-voicemail call.

By way of example, the system may process at least three audio frames before it classifies a call as a non-voicemail call. Accordingly, if the audio frame analyzed at 210a is not a voicemail audio, then the method may return to act 204a and the analysis is repeated for two more captured audio frames before a final determination is made. If the method loops back to act 204a, the method may also skip over act 206a, since all subsequent audio samples will naturally proceed the ringtone.

If at 216a, the predetermined number of frames are analyzed, then at 218a, the system may classify the call as a non-voicemail call. This may be because a human has answered the call. A non-voicemail classification may also occur if the system does not recognize the voicemail at 208a, such as if the user has updated their voicemail message.

In view of the foregoing, method 200a classifies voicemail calls in real time or near real time by capturing and analyzing audio sample frames in real time or near real time. In other words, as the call is in progress, the system captures real time audio frames (act 204a) and analyzes the audio frames one after another to determine if the call is a voicemail call or not.

If each audio frame is approximately 0.2 seconds long, the system can identify a voicemail call in as little as 0.2 seconds if the first frame is matched to a voicemail message. Alternatively, if the system considers two additional audio frames (act 216a), then the system identifies a voicemail in as little as 0.6 seconds. This speed is fast enough to allow the system time respond to a person called without a noticeable delay, and rapidly connecting or disconnecting the call to an agent.

### (ii.) Generating Reference VM Recording

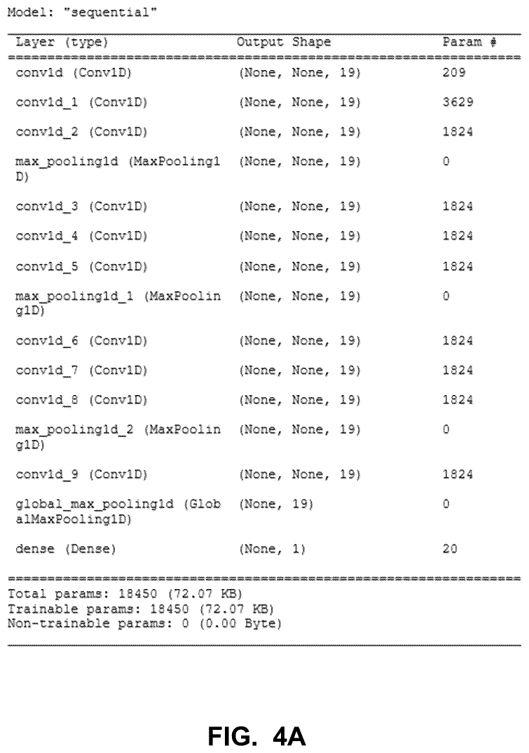

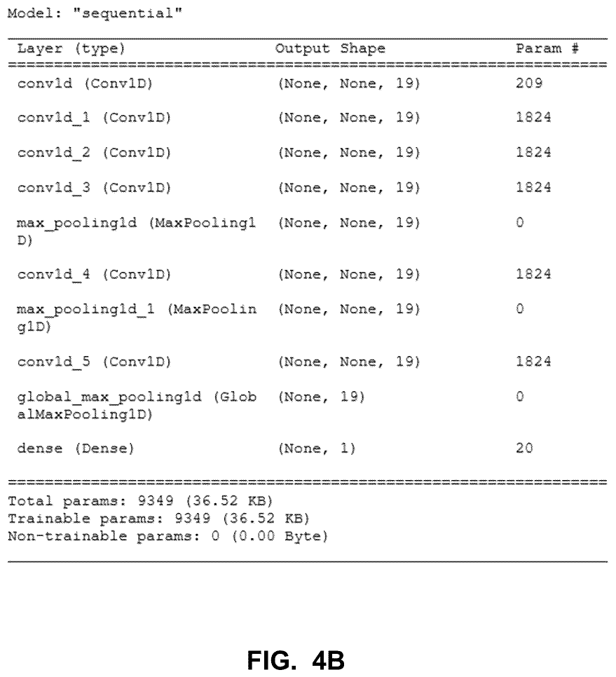

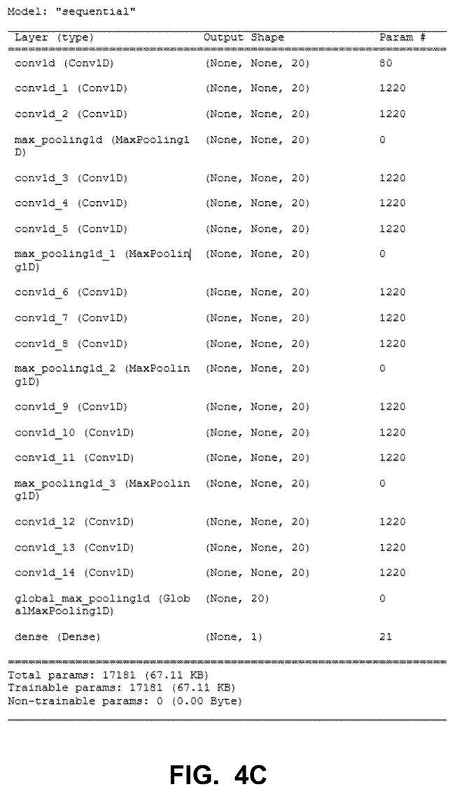

FIG. 2B shows a process flow for an example method 200b for generating a reference VM database 104c for various telephone numbers. In some examples, the method 200b is performed or executed by a processor 502 of the predictive dialer server 102 (FIG. 4).

At 202b, the server 102 initiates a call to a telephone number associated with a user device 106.

In some examples, the user device 102 being called is associated with a telephone number that does not have a reference VM stored in the database 104c. In other cases, the telephone number is associated with a reference VM, however, the VM has updated or changed and the database 104c needs updating with a new reference VM sample.

At 204b, the system may initiate a recording of the call. It is possible that, as the call is recorded, the call is also automatically connected to an agent 108 in the ordinary course. At 206b, it is determined whether the call is completed. For example, this determination is made based on receiving a call disconnect event. If the call is not completed, the system can continue recording the call.

Otherwise, if the call is completed, the system may, at a subsequent time, analyze the call recording to: (i) determine if the call is a voicemail call (acts 208b-220b); and (ii) if so, extract a recording of the voicemail as a reference VM sample for storing in reference database 104b (acts 222b-224b).

### (a) Classifying the Call as a Voicemail Call

At acts 208b-220b, the system initially processes the recorded audio call to determine if it is a voicemail call.

At 208b, the recorded audio is initially pre-processed to remove any ringtone sounds, i.e., from the start of the audio file. This is important to ensure that the call is not misclassified as a voicemail call due to the ringtone sound being mistaken for a voicemail tone.

In some examples, the ringtone is identified and removed by applying a ringtone detection technique. For example, ringtone detection is performed using a Goertzel algorithm, as explained previously. Once a ringtone is identified, it may be removed from the audio (or at least, removed from further processing). The resulting audio data, after removing ringtone portions, may be referenced herein as the “processable” portion of the recorded audio, since this is the non-ringtone portion further processed by the system to extract a VM sample.

In some cases, the recorded audio is also initially converted to a 16-bit PCM format (e.g., from a μ-law format), captured at a predefined sample rate (e.g., 8,000 samples per second).

At 210b, the system may initially apply the recorded voicemail (VM) detection model 104a (FIG. 1). The recorded VM detection model 104a is a machine learning model trained to identify common voicemail greetings in recorded audio calls. The recorded VM model 104a is trained on a dataset of standard recorded voicemail greetings and is trained to classify audio as voicemail or not.

In at least one example, the recorded VM detection model 104a is applied to a 1,000 ms audio sample of the processable recorded audio. For example, the model 104a is applied to the initial 1,000 ms of the processable recorded audio, which is input into the model as a digital array.

At 212b, the system determines if a voicemail greeting is detected, based on application of the recorded VM detection model 104a. If a voicemail is detected at 212b, then at 214b the call is classified as a voicemail call.

Otherwise, at 216b, the system applies a VM tone detection model 104b (FIG. 1). The purpose of the tone detection model 104b is to detect a voicemail tone. This is because in some cases, a voicemail call does not include a standard greeting, but may include a customized voicemail greeting and a voicemail tone prompting the caller to leave a message.

The tone detection model 104b is also a machine learning model that is trained to identify various voicemail tone sounds. The tone detection model 104b is trained on a training dataset of standard voicemail tones audio samples. In use, the tone detection model 104b can also receive an input array of the processable audio call. This may be the same input used in the recorded VM detection model 104a, e.g., a 200 ms audio sample.

If no tone is detected at 218b, then at 220b, the system may classify the call as a non-voicemail call. Otherwise, at 214b, the call is classified as a voicemail call.

In some cases, acts 208b and 214b may be reversed. For example, it is possible that the tone detection model 104b is applied before the recorded VM detection model 104a. In this manner acts 208b and 210b are swapped with acts 214b and 216b. In other examples, acts 206b and 214b are performed concurrently. In other words, the model may apply both the recorded VM model 104a and the tone model 104b concurrently, or partially concurrently.

In some examples, it is also possible that only one of the models is applied. For example, only acts 208b-210b are applied using the recorded VM model 104a.

### (b) Extracting Reference VM Sample

At acts 222b-224b, once the call is classified as a voicemail call, the system may then analyze and process the audio call to extract a reference voicemail (VM) sample recording.

At 222b, the system analyzes the recorded audio to extract a reference voicemail sample.

In at least one example, the system extracts the reference voicemail audio by determining a timestamp for the connection or confirmation event. For example, as the audio is recorded at 204b, the system may monitor when the connection event is received. As indicated previously, the connection event corresponds to the time instance when the call is connected because of a voicemail message or tone.

In some examples, the system extracts the reference VM as a predefined interval of audio directly after the confirm event timestamp. For example, this may be a 200 ms audio sample frame.

In other examples, the system extracts a predefined interval of audio commencing from shortly before the confirm event timestamp. For example, the sample extraction can occur starting from 1 to 2 seconds before the confirm event timestamp. This is because in many cases, the confirm event is not delivered exactly when the call is connected.

At 224b, the system stores the extracted reference VM sample in association with the telephone number, such as storing it in the reference VM database 104c.

### (iii.) Voicemail Detection

FIG. 2C shows a process flow for an example method 200c for classifying voicemail calls. Method 200c can be performed by a processor 502 of the server 102.

At 202c, the server selects a telephone number to call.

At 204c, a determination is made as to whether a reference voicemail is stored in association with that number, e.g., in reference database 104c. If not, then the method proceeds to act 202b (FIG. 2B) to generate and store a reference voicemail sample in association with that number. Otherwise, if a reference voicemail is available, the system proceeds to act 202a to use the reference voicemail to classify the call as a voicemail call or not.

### (iv.) Updating Voicemail Recording

In some examples, method 200b may be performed concurrently with method 200a.

For example, after the call is initiated at 202a (FIG. 2A), method 200b may initiate acts 202b to record the call. If at 218a (FIG. 2A) a voicemail call is not detected, the system can proceed to analyze the recorded call at a subsequent time using acts 208b to 220b (FIG. 2B). If the system determines that the call was a voicemail call using method 200b (FIG. 2B), despite being undetected, the system may determine that the user has updated their voicemail. Accordingly, at 224b, the system may store a new or updated VM in association with the same number.

In some examples, prior to updating the voicemail sample recording, the system can also initially determine if a voicemail was not detected in FIG. 2A because of poor quality recorded audio signals. For example, sometimes audio packets are lost which introduces noise into the recordings. Accordingly, the system can check for lost packets before updating the recordings to make sure the system received a high quality recording. In at least one example, lost packets are detected by analyzing the audio call recording to identify portions comprising elongated strings of zero packets.

### (v.) Multiple Recorded Numbers

In some examples, the reference VM database 104c can store more than one voicemail per number. This is because the voicemail greeting may differ for a phone number depending on how the voicemail is reached. For instance, if the call is forwarded to voicemail because it exceeded the maximum rings, the greeting may be different than if the phone user was talking on the phone when they received another call.

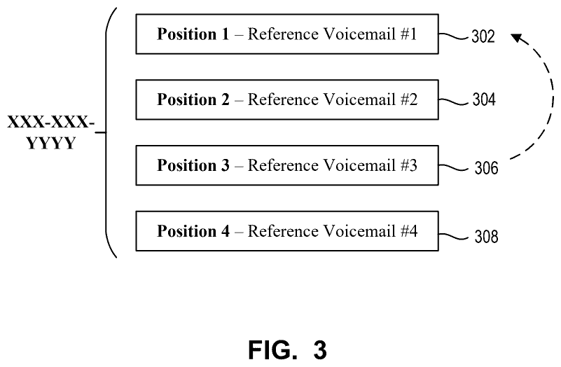

Accordingly, in method 200b, it is possible that the method is repeated multiple times for the same number such as to store different voicemails in association with the same number at act 224b. This is shown by way of example in FIG. 3, which illustrates multiple reference voicemails 302-308 stored in association with the same phone number “XXX-XXX-YYYY”.

Accordingly, during method 200a (FIG. 2A), at 208a, it is possible that more than one reference voicemail sample 302-308 (FIG. 3) is accessed in association with the same number. As such, when the audio samples frames are analyzed at act 208a to classify the call as a voicemail call, the audio sample frames are compared to multiple reference voicemail samples associated with the same number.

In some examples, where multiple reference voicemails (VMs) are stored in association with the same number, they are stored in a priority positional order. The positional order indicates the order in which the reference VMs are cross-referenced against the captured audio sample (at 208a in FIG. 2A). For example, in FIG. 3, the audio sample is initially compared to a first position reference VM 302, followed by a second position reference VM 304, and so on.

In at least one example, the reference VMs 302-308 are ordered based on their occurrence frequency. For example, first VM position 302 stores the reference VM that most often occurs when calling the number, followed by the second VM position 304, etc. The system can therefore monitor the frequency occurrence of different VMs each time the same number is called. The system then stores reference VMs in different positional orders depending on their occurrence frequency.

To this end, in order to monitor the occurrence frequency of VMs, the system may apply the cross-correlation at act 208a (FIG. 2A) to compare the captured VM to the reference VMs. If a match is detected, the system adds to the occurrence frequency count for that VM.

In some cases, by positionally ordering the voicemails based on occurrence frequency, the system minimizes voicemail detection time (at 208a in FIG. 2A) where multiple voicemail greetings are associated with the same number. This is because the system initially cross-references the captured audio sample with the most occurring reference voicemail—stored in the first VM position 302—to increase voicemail detection probability. If the detection is not successful, the system may then cross-reference the voicemail to the second VM position 304, and so forth.

It is possible, as well, that the voicemails are ordered based on other priority factors, aside from only occurrence frequency. For instance, different priority orderings may be provided for different times of day, or times/seasons of the year when certain voicemails are more likely to occur than others.

In some examples, it is possible that the system may still detect further VMs for the same number, even if the maximum number of reference VMs are stored for that number. In these cases, the system can overwrite the lowest priority voicemail (e.g., last VM position 308 in FIG. 3) with the new reference recording. In this manner, the priority ordering of voicemails also facilitates determining which reference VM can be overwritten.

### (v.) Continued Monitoring of VMs

In some examples, if a voicemail is not initially detected at acts 208a-210a (FIG. 2A) based on a shorter audio sample (200 ms)—as the system is connecting the call to an agent (act 220a) it may continue to record a longer audio sample (e.g., 1000 ms) and apply the recorded VM detection model 104a. If the system detects a voicemail based on the longer audio sample, it may classify the call as a VM and automatically disconnect the call.

### IV. Training Machine Learning Models

As shown in FIG. 1, there are three (3) models used for voicemail detection: (i) a recorded VM detection model 104a; (ii) a VM tone detection model 104b; and (iii) a live VM detection model 104d. Each of these models may be a trained machine learning model.

### (i.) Training Data Generation.

In at least one example, training data is generated by taking samples from audio recordings of calls. The audio recordings may be recorded in a μ-law format. Each audio recording is initially converted to signed 16 bit PCM samples.

In some examples, the training samples are manually generated. For example, a large volume of recorded phone calls are manually reviewed, and standard greetings are manually extracted from these phone calls to generate both 200 ms samples and 1,000 ms samples. The 200 ms greetings are then used for training the live VM detection model 104d, while the 1,000 ms greetings are used for training the recorded VM detection model 104a. The training dataset can include various types of standard greetings. Various different types of voicemail tones are also extractable from recorded phone calls.

In at least one example, an automated noise filter is used to facilitate extraction of standard voicemail greetings and voicemail tones from recorded phone calls. The automated noise filter scans the recorded audio and identifies if the noise level exceeds certain predetermined thresholds. If the noise level exceeds a certain threshold, it indicates that the audio portion likely corresponds to a voicemail greeting or tone. Different thresholds are defined for voicemail greetings versus tones. Accordingly, this simplifies manual review and extraction of training samples by automatically identifying potential candidates for voicemail greetings and tones in the recorded audio.

The audio may be searched using a noise filter comprising a root mean square (RMS) measure. Audio samples are then included in the candidate training dataset if the percentage of frames that exceed a predefined threshold is higher than a specific percentage. In some examples, the percentages of frames is 80% for the live VM detection model 104d (using a 200 ms sample), and 50% for both the recorded VM detection model 104a (using a 1,000 ms sample) and the VM tone detection model 104b.

In the case of the tone detection model 104b, samples are also eliminated where the noise threshold of the sample is very high for 40% of the frames in a sample.

Once samples are selected, the samples are normalized by dividing the value by 1,000. These sample are then used to train the models.

### (ii.) Training Methodology

In at least one example, all models 104a, 104b and 104d are trained using an Adam optimizer. A binary cross-entropy loss may be used for training.

The following Keras fit functions was used, which indicate the number of training epochs, batch size and validation splits:
Recorded VM Detection Model 104a: The Keras fit function used was: model.fit(x_train, y_train, epochs=100, class_weight={0:15,1:1}, batch_size=128, callbacks=callbacks_list, validation_split=0.05)
VM Tone Detection Model 104b: The Keras fit function used was: model.fit(x_train, y_train, class_weight={0:3,1:1}, epochs=30, batch_size=128, callbacks=callbacks_list)
Live VM Detection Model 104d: The Keras fit function used was: model.fit(x_train, y_train, epochs=50, class_weight={0:15,1:1}, batch_size=128, callbacks=callbacks_list, validation_split=0.05) In each Keras fit function, class weighting for class “0” (‘not VM’, or ‘not VM tone’) may be weighted more heavily to prevent false positives.

### (iii.) Trained Model Application

The sampling and normalizing are applied during the inference stage when applying the trained models. The models all predict the probability that a sample is a VM or a tone. If this probability exceeds a model specific threshold then the result is considered positive. In at least one example, model specific probabilities are: (i) 0.99 for the recorded VM detection model 104a; (ii) 0.90 for the VM tone detection model 104b; and (iii) 0.99 for the live VM detection model 104d.

### (iv.) Model Architectures

In at least one example, the trained model architectures are as follows:
Recorded VM Detection Model 104a: An example architecture for this model is shown in FIG. 4A
VM Tone Detection Model 104b: An example architecture for this model is shown in FIG. 4B.
Live VM Detection Model 104d: An example architecture for this model is shown in FIG. 4C.

### (v.) Final Results

The final accuracy results of each model were: (i) recorded VM detection model 104a (94.6% accuracy with the test data and 0 false positives); (ii) VM tone detection model 104b (98% accuracy with the test data and 0 false positives); and (iii) live VM detection model 104d (80% accuracy with the test data and 0 false positives).

### V. Example Hardware Configuration

FIG. 5 shows an example hardware configuration for an example processing server 102 As shown, the server 102 includes a processor 502 coupled (e.g., via a computer data bus) to one or more of a memory 504, a communication interface 506 and an input/output (I/O) interface 508.

Processor 502 includes to one or more electronic devices that is/are capable of reading and executing instructions stored on a memory to perform operations on data, which may be stored in a memory or provided in a data signal. The term “processor” includes a plurality of physically discrete, operatively connected devices despite use of the term in the singular. Non-limiting examples of processors include devices referred to as microprocessors, microcontrollers, central processing units (CPU), and digital signal processors. In some embodiments, the processing unit comprises a stand-alone embedded processor system, optionally connected to a standard computer. In some embodiments, the embedded processor system may comprise a microcontroller and a Field Programmable Gate Array (FPGA). The processor is linked to a memory which includes instructions to implement the scanning and imaging steps described herein.

Memory 504 includes a non-transitory tangible computer-readable medium for storing information in a format readable by a processor, and/or instructions readable by a processor to implement an algorithm. The term “memory” includes a plurality of physically discrete, operatively connected devices despite use of the term in the singular. Non-limiting types of memory include solid-state, optical, and magnetic computer readable media. Memory may be non-volatile or volatile. Instructions stored by a memory may be based on a plurality of programming languages known in the art, with non-limiting examples including the C, C++, Python™, MATLAB™, and Java™ programming languages.

To that end, it will be understood by those of skill in the art that references herein to server 102 as carrying out a function or acting in a particular way imply that processor 502 is executing instructions (e.g., a software program) stored in memory 504 and possibly transmitting or receiving inputs and outputs via one or more interfaces. Communication interface 506 may comprise a cellular modem and antenna for wireless transmission of data to the communications network. In some examples, where the above described methods are preformed using external computing devices (e.g., external servers), these external computing devices may communicate to receive and transmit data to processor 502, via the communication interface 506.

I/O interface 508 can be used to connect the server 102 to other external devices.

### VI. Interpretation

Various systems or methods have been described to provide an example of an embodiment of the claimed subject matter. No embodiment described limits any claimed subject matter and any claimed subject matter may cover methods or systems that differ from those described below. The claimed subject matter is not limited to systems or methods having all of the features of any one system or method described below or to features common to multiple or all of the apparatuses or methods described below. It is possible that a system or method described is not an embodiment that is recited in any claimed subject matter. Any subject matter disclosed in a system or method described that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling may be used to indicate that an element or device can electrically, optically, or wirelessly send data to another element or device as well as receive data from another element or device. As used herein, two or more components are said to be “coupled”, or “connected” where the parts are joined or operate together either directly or indirectly (i.e., through one or more intermediate components), so long as a link occurs. As used herein and in the claims, two or more parts are said to be “directly coupled”, or “directly connected”, where the parts are joined or operate together without intervening intermediate components.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

The example embodiments of the systems and methods described herein may be implemented as a combination of hardware or software. In some cases, the example embodiments described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a pushbutton keyboard, mouse, a touchscreen, and the like), and at least one output device (e.g. a display screen, a printer, a wireless radio, and the like) depending on the nature of the device.

It should also be noted that there may be some elements that are used to implement at least part of one of the embodiments described herein that may be implemented via software that is written in a high-level computer programming language such as object oriented programming or script-based programming. Accordingly, the program code may be written in Java, Swift/Objective-C, C, C++, Javascript, Python, SQL or any other suitable programming language and may comprise modules or classes, as is known to those skilled in object oriented programming. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage. The computer program product may also be distributed in an over-the-air or wireless manner, using a wireless data connection.

The term “software application” or “application” refers to computer-executable instructions, particularly computer-executable instructions stored in a non-transitory medium, such as a non-volatile memory, and executed by a computer processor. The computer processor, when executing the instructions, may receive inputs and transmit outputs to any of a variety of input or output devices to which it is coupled. Software applications may include mobile applications or “apps” for use on mobile devices such as smartphones and tablets or other “smart” devices.

A software application can be, for example, a monolithic software application, built in-house by the organization and possibly running on custom hardware; a set of interconnected modular subsystems running on similar or diverse hardware; a software-as-a-service application operated remotely by a third party; third party software running on outsourced infrastructure, etc. In some cases, a software application also may be less formal, or constructed in ad hoc fashion, such as a programmable spreadsheet document that has been modified to perform computations for the organization's needs.

The present invention has been described here by way of example only, while numerous specific details are set forth herein in order to provide a thorough understanding of the exemplary embodiments described herein. However, it will be understood by those of ordinary skill in the art that these embodiments may, in some cases, be practiced without these specific details. In other instances, well-known methods, procedures and components have not been described in detail so as not to obscure the description of the embodiments. Various modification and variations may be made to these exemplary embodiments without departing from the spirit and scope of the invention, which is limited only by the appended claims.

1. A method for automated detection of voicemail calls, the method comprising:
initiating a call to a telephone number associated with a user device;
capturing at least one audio sample frame from the call;
analyzing the audio sample frame to determine if the call is a voicemail call; and
if the call is a voicemail call, dropping the call connection, otherwise connecting the call to an agent operator device.

2. The method of claim 1, wherein analyzing the audio sample frame to determine if the call is a voicemail call comprises:
comparing each audio sample frame to a reference voicemail sample associated with the telephone number.

3. The method of claim 2, wherein the comparison is performed by comparing an array of the audio sample to an array of the reference voicemail sample.

4. The method of claim 3, wherein the comparison is performed by determining a cross correlation between the two numerical arrays.

5. The method of claim 4, wherein the call is determined to be a voicemail call if the highest normalized correlation value exceeds a predetermined threshold.

6. The method of claim 1, wherein analyzing the audio sample frame to determine if the call is a voicemail call comprises:
applying a live voicemail detection model to the audio sample frames, the live voicemail detection model comprising a trained machine learning model.

7. The method of claim 1, wherein prior to analyzing, the method comprises:
applying ringtone detection to detect audio sample frames comprising a ringtone, and analyzing audio sample frames not comprising a ringtone.

8. The method of claim 7, wherein the ringtone detection is performed using a Goertzel algorithm.

9. The method of claim 2, further comprising, initially generating the reference voicemail sample by:
initiating an initial call to the telephone number;
recording the initial call to generate an audio call recording;
applying a recorded voicemail detection model to the audio call recording to determine if the audio call is a voicemail call;
if the call is a voicemail call, extracting a reference voicemail sample from the audio call recording; and
storing the reference voicemail sample in association with the telephone number.

10. The method of claim 9, further comprising applying a tone detection model to the audio call recording to determine if the audio call recording is a voicemail call.

11. A system for automated detection of voicemail calls, the system comprising:
a communication interface; and
at least one processor coupled to the communication interface, the at least one processor configured for:
initiating, via the communication interface, a call to a telephone number associated with a user device;
capturing at least one audio sample frame from the call;
analyzing the audio sample frame to determine if the call is a voicemail call; and
if the call is a voicemail call, dropping the call connection, otherwise connecting the call to an agent operator device.

12. The system of claim 11, wherein analyzing the audio sample frame to determine if the call is a voicemail call comprises the at least one processor being configured for:
comparing each audio sample frame to a reference voicemail sample associated with the telephone number.

13. The system of claim 12, wherein the comparison is performed by comparing an array of the audio sample to an array of the reference voicemail sample.

14. The system of claim 13, wherein the comparison is performed by determining a cross correlation between the two numerical arrays.

15. The system of claim 14, wherein the call is determined to be a voicemail call if the highest normalized correlation value exceeds a predetermined threshold.

16. The system of claim 11, wherein analyzing the audio sample frame to determine if the call is a voicemail call comprises the at least one processor being configured for:
applying a live voicemail detection model to the audio sample frames, the live voicemail detection model comprising a trained machine learning model.

17. The system of claim 11, wherein prior to analyzing, the at least one processor is further configured for:
applying ringtone detection to detect audio sample frames comprising a ringtone, and analyzing audio sample frames not comprising a ringtone.

18. The system of claim 17, wherein the ringtone detection is performed using a Goertzel algorithm.

19. The system of claim 12, wherein the at least one processor is further configured for, initially generating the reference voicemail sample by:
initiating an initial call to the telephone number;
recording the initial call to generate an audio call recording;
applying a recorded voicemail detection model to the audio call recording to determine if the audio call is a voicemail call;
if the call is a voicemail call, extracting a reference voicemail sample from the audio call recording; and
storing the reference voicemail sample in association with the telephone number.

20. The system of claim 19, wherein the at least one processor is further configured for:
applying a tone detection model to the audio call recording to determine if the audio call recording is a voicemail call.
